(19) United States
(12) Patent Application Publication
(10) Pub. No.: US 2016/0247184 A1
(43) Pub. Date: Aug. 25, 2016

(54) RETAIL SAVINGS LEADERBOARD

(71) Applicant: Target Brands, Inc., Minneapolis, MN (US)

(72) Inventors: Amber M. Reimer, Minneapolis, MN (US); Sarah Roxanne Peterson, St. Paul, MN (US)

(21) Appl. No.: 14/626,245

(22) Filed: Feb. 19, 2015

(51) Int. Cl. G06Q 30/02; G06Q 50/00

(52) U.S. Cl. CPC G06Q 30/0236; G06Q 50/01; G06Q 30/0239

(57) ABSTRACT

A list of users of a savings application is identified based on a logged-in user of the savings site and a linking criterion. A savings amount for each user in the list of users is determined where the savings amount is in part based on an amount saved on retail purchases using the savings application. A user interface is generated that displays the list of users and the savings amount for each user as an ordered list based on savings amounts.

### BACKGROUND

Retailers publish discounts and sales offers on the Internet. Consumers can select an offer and use it during an electronic transaction or print the offer and redeem it during a transaction at a physical store.

“Social media” includes a collection of Internet and/or cellular network technologies that allow people to share information about their lives. In many of these technologies, a list of friends or followers is associated with a particular user such that when the user updates information about their lives, their friends or followers are notified. In some social media settings, when a user takes an action on an Internet page, that action is automatically updated on the user's social media postings so that their friends and followers are made aware of the user's actions.

The discussion above is merely provided for general background information and is not intended to be used as an aid in determining the scope of the claimed subject matter. The claimed subject matter is not limited to implementations that solve any or all disadvantages noted in the background.

### SUMMARY

A set of users of a savings application is identified based on a logged-in user of the savings site and a linking criterion. A savings amount for each user in the set of users is determined where the savings amount is in part based on an amount saved on retail purchases using the savings application. A user interface is generated that displays the set of users and the savings amount for each user as an ordered list based on savings amounts.

A processor provides a user interface showing a set of users ordered by the amount of money each user saved by redeeming retail offers.

A server identifying a set of users associated with a current user, the current user and each user in the set of users having a respective username. For each user in the set of users and the current user, the server retrieves an amount the user saved by redeeming offers. The server transmits a list containing the username of the current user and usernames of each user in the set of users ordered based on the amounts saved by redeeming offers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is block diagram of a system used to generate a savings leaderboard user interface under one embodiment.

FIG. 2 is a flow diagram of method of generating a savings leaderboard user interface.

FIG. 3 is a flow diagram of method of generating a savings leaderboard user interface using a social media contacts linking criterion.

FIG. 4 is a flow diagram of method of generating a savings leaderboard user interface using demographic and/or shopping behavior attributes as linking criterion.

FIG. 5 is an example of a user interface showing a tab for a savings leaderboard.

FIG. 6 is an example of a user interface showing a savings leaderboard.

FIG. 7 is a block diagram of a mobile device that can be used with various embodiments.

FIG. 8 is a block diagram of a computing device that can be used with various embodiments.

### DETAILED DESCRIPTION

Embodiments described below provide a user interface that shows a savings leaderboard. The savings leaderboard is a list of users that are ranked based on the amount they have saved by redeeming offers at one or more retail stores. In one embodiment, the list of users is formed of users that are social media contacts on a social media site. In other embodiments, the list of users is formed of users that share a demographic or shopping behavior attribute with a current user.

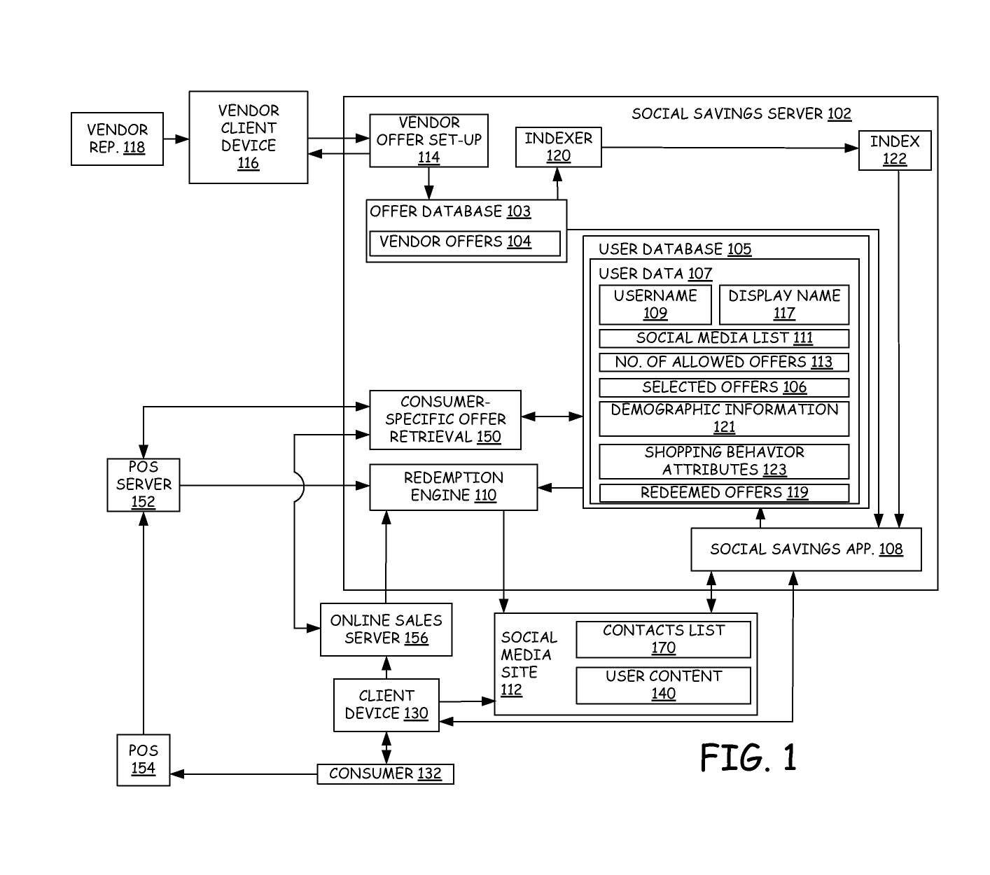

FIG. 1 provides a block diagram of elements used for setting, selecting and redeeming offers in the context of an offer sharing system and for creating a leaderboard of savers. In FIG. 1, a social savings server 102 provides user interfaces to allow vendors to create and store vendor offers 104. To create new offers, a vendor representative 118 uses a vendor client device 116 to interact with a vendor offer set-up application 114. Vendor offer set-up application 114 may take the form of a collection of webpages having code behind that allow the webpages to execute application functions and to store and retrieve data in offer database 103. Using the webpages provided by vendor offer set-up application 114, the vendor is able to provide a description of the offer, list the products associated with the offer, the expiration date of the offer and to designate an image or video that is to accompany the offer.

Upon receiving the offer information, vendor offer set-up application 114 stores the offer information in offer database 103 as one of vendor offers 104. Thus, offer database 103 holds information about offers or discounts provided by vendors. An indexer 120 creates an index 122 that is keyed by words and product names found in vendor offers 104. For each term/product name, index 122 provides a list of offers that contain that term or product name.

Social savings server 102 also includes a social savings application 108, which is an offer searching application, an offer selection application, an offer sharing application and a savings leaderboard application. Since social savings application 108 can be realized as a collection of web pages with code behind to allow it to perform various functions, social savings application 108 is also an offer searching site, and offer selection site, an offer sharing site and a savings leaderboard site. Index 122 may be searched using a search user interface provided by social savings application 108. In particular, social savings application 108 provides a search user interface to client device 130 that provides a text box where a consumer 132 may enter terms and product names to be searched. When consumer 132 submits a search query, social savings application 108 searches index 122 and retrieves all offers that match the search query. Social savings application 108 then returns the matching offers to client device 130 in a search results user interface.

Consumer 132 is able to select one or more of the offers in the search results user interface. When an offer is selected by consumer 132, social savings application 108 adds the offer to a user database 105. User database 105 is stored in memory and holds information about registered users of social savings application 108. In particular, for each user of social savings application 108, user database contains a user data record 107 that includes a username 109 that uniquely identifies the user on social savings application 108, a display name 117 to be displayed on user interfaces generated by social savings application 108, social media list 111 that lists social media sites associated with the user, selected offers 106, which is a set of offers, also referred to as a group of discounts, selected by the user for later redemption, number of allowed offers 113 representing the maximum number of offers allowed in selected offers 106 at any one time, and redeemed offers 119, which represents a set of offers that have been redeemed by the user in the past as well as the monetary value of the savings associated with each redeemed offer. When consumer 132 selects an offer, social savings application 108 adds the offer to selected offers 106 in the consumer's user data 107 of user database 105.

As noted in the description of database 105, the selection of an offer is different from the redemption of an offer. When an offer is selected, it is designated as being available to the consumer for later redemption. When an offer is redeemed, the discount provided by the offer is applied to the consumer's purchase to reduce the amount paid by the consumer. Once an offer is redeemed, it is removed from selected offers 106 and is added to redeemed offers 119.

Number of allowed offers 113 can be a constant number that is the same for all users of social savings application 108 or can be dynamic and user-specific such that it increases with certain actions of a user. For example, if a user invites social media contacts to join social savings application 108, the number of allowed offers 113 can be increased. In accordance with one embodiment, the number of allowed offers 113 is initially set to ten.

Consumer 132 may redeem an offer by going to a retail store or making an online purchase. When consumer 132 goes to a retail store, they select products from the shelves of the store and bring the products to a point-of-sale register 154 for checkout. During checkout, consumer 132 provides a consumer identifier (ID) to point-of-sale register 154. For example, consumer 132 can slide a credit card or savings card through a magnetic reader attached to point-of-sale register 154 and thereby transfer the consumer ID to point-of-sale register 154. In other embodiments, consumer 132 may provide their consumer ID using a radio frequency signal provided by a radio frequency transmitter held by consumer 132, providing a Bluetooth® signal through a handheld device held by consumer 132 or providing a signal over a wireless network through a handheld device held by consumer 132, for example. In still further embodiments, consumer 132 may present an electronic barcode displayed on a mobile device held by consumer 132. The electronic barcode is read by a barcode reader at POS 154 to generate the consumer ID. The electronic barcode may be provided to the mobile device through social savings application 108. Point-of-sale register 154 provides the consumer ID to point-of-sale server 152, which then uses the consumer ID to request offers selected by the consumer associated with the consumer ID.

Specifically, point-of-sale server 152 passes the request to consumer-specific offer retrieval application 150, which accesses user database 105 to retrieve selected offers 106 for a username 109 that correlates to the consumer ID. In accordance with some embodiments, username 109 may not be the same as the consumer ID provided by consumer 132. In such cases, a mapping may occur in which the consumer ID provided by consumer 132 is converted into username 109 by one of point-of-sale register 154, point-of-sale server 152 or consumer-specific offer retrieval application 150. For example, a mapping table or a mapping algorithm may be used to convert a consumer ID provided at point-of-sale register 154 into a username as found in user database 105.

Consumer-specific offer retrieval application 150 returns selected offers 106 to point-of-sale server 152, which then forwards selected offers 106 to point-of-sale register 154. Point-of-sale register 154 compares the items listed in selected offers 106 to items being purchased in the current transaction. In order for point-of-sale register 154 to identify offers that are being redeemed, the offer information provided by consumer-specific offer retrieval application 150 should identify the products associated with an offer by, for example, providing a universal product code, a global trade item number, a stock keeping unit (SKU), or a retailer-specific identifier for the product. If items being purchased match items associated with one or more offers, each of the offers that match are designated as redeemed offers by point-of-sale register 154 and the offers are applied to the transaction to reduce the amount charged to consumer 132. Point-of-sale register 154 then indicates to point-of-sale server 152 which of selected offers 106 were redeemed. Point-of-sale server 152 provides information about the redeemed offers to redemption engine 110, which removes the redeemed offers from selected offers 106 and adds the redeemed offers to redeemed offers 119. Removing the redeemed offers from selected offers 106 and adding them to redeemed offers 119 can involve changing a status of the offers from “selected” to “redeemed” in user data 107.

A request for consumer-specific offers may also be provided by an online sales server 156 in response to a sales transaction between online sales server 156 and client device 130. Although client device 130 is shown as the same client device used to select offers, those skilled in the art will recognize that consumer 132 may use different client devices for selecting offers than for performing sales transactions with online sales server 156. For example, consumer 132 may use a handheld client device such as their phone for selecting offers and may use a second client device such as a laptop computer or tablet computer to perform sales transactions with online sales server 156.

Online sales server 156 receives a consumer ID from client device 130 and forwards the consumer ID to consumer-specific offer retrieval application 150 in a request for offers that have been selected by consumer 132. Online sales server may receive the consumer ID by having the consumer login to online sales server 156 using the consumer ID or by requesting the consumer ID from client device 130. Client device 130 may retrieve the consumer ID from a storage location on client device 130 or may request the consumer ID from consumer 132. In accordance with some embodiments, the consumer ID provided by client device 130 does not have to match username 109 stored in user database 105 for consumer 132. In such embodiments, online sales server 156 or consumer-specific offer retrieval application 150 may convert the consumer ID provided by client device 130 into username 109 using a mapping table or a mapping algorithm.

Consumer-specific offer retrieval application 150 retrieves selected offers 106 of user data 107 associated with the consumer ID. Consumer-specific offer retrieval application 150 returns the offer information for selected offers 106 to online sales server 156. Online sales server 156 identifies items that are being purchased and compares those items to items associated with the selected offers returned by consumer-specific offer retrieval application 150. Items that match a selected offer cause the selected offer to be designated as a redeemed offer, and the terms of the offer are applied to the purchase to reduce the amount charged to consumer 132.

Online sales server 156 then provides a list of redeemed offers to redemption engine 110. Redemption engine 110 updates selected offers 106 to remove the redeemed offers and adds the redeemed offers to redeemed offers 119 in user data 107. Removing the redeemed offers from selected offers 106 and adding them to redeemed offers 119 can involve changing a status of the offers from “selected” to “redeemed” in user data 107.

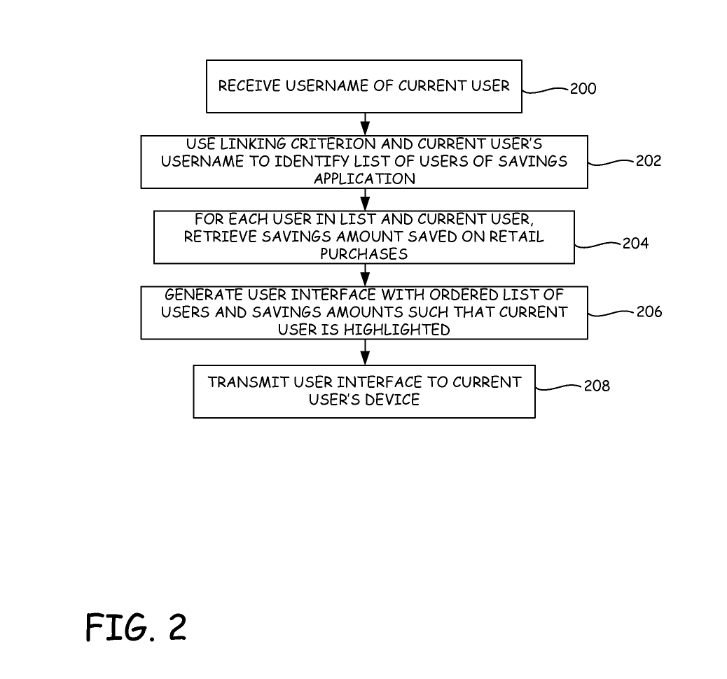

FIG. 2 provides a flow diagram of a method of generating and displaying a savings leaderboard based on the redemption of offers using the system of FIG. 1. In step 200, a username for a current user is received. The username may be received in response to a login screen sent to client device 130 by social savings application 108. Alternatively, the username may be received in response to a login screen provided by social media site 112 to client device 130. In such embodiments, social saving application 108 calls a login function on social media site 112. In response, social media site 112 presents the login screen to client device 130 and consumer 132 logs into the social media site 112. If the login is successful, social media site 112 provides the username for the consumer to social savings application 108 along with a token that can be used to gain access to information stored on social media site 112 for an account associated with the username.

At step 202, a linking criterion and the current user's username are used to identify a list of users of social savings application 108. One example of a linking criterion is users who are social media contacts of the current user and who are also users of social savings application 108. Other examples of linking criterion include users of social savings application 108 that have similar demographic information as the current user and users of social savings application 108 that have similar shopping behavior attributes as the current user.

At step 204, a savings amount is retrieved for each user in the list of users determined at step 202. This savings amount is stored in user data 107 as part of redeemed offers 119 and represents the amount of money each user has saved by redeeming offers at a retail store. In one embodiment, the amount of money a user has saved by redeeming offers includes amounts saved by redeeming offers at physical (brick-and-mortar) stores and at online stores. In some embodiments, the savings amount is a total amount saved since the user started using social savings application 108. In other embodiments, the savings amount is the amount the user has saved over some period of time such as year-to-date, the past year, and the past month, for example.

At step 206, social savings application 108 generates a savings leaderboard user interface that contains an ordered list of the users identified in step 202, wherein the users are ordered based on the savings amounts retrieved at step 204. The ordered list includes a display name for each user in the list, the savings amount for each user, and optionally an image associated with each user. In some embodiments, the current user's display name is highlighted in the ordered list so that it is easier for the current user to locate their display name in the ordered list. The ordered list can also include a rank number for each user in the list to indicate where each user ranks relative to the other users in the ordered list.

At step 208, social savings application 108 transmits the user interface generated in step 206 to the current user's device, such as client device 130 of FIG. 1. The portion of the user interface containing the ordered list can be transmitted when the user first logs into the social savings application or when the user selects a control on a user interface to request the ordered list.

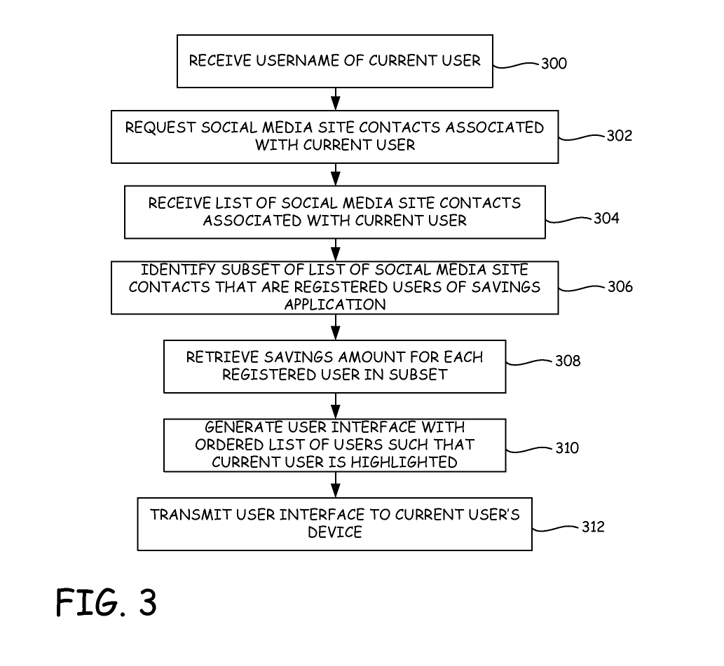

FIG. 3 provides a flow diagram of a method of generating and displaying a savings leaderboard based on a linking criterion of social media contacts. At step 300, a username of a consumer 132 is received by social savings application 108. In accordance with one embodiment, the username is received by social savings application 108 through a call to a login function on social media site 112. When the login function is called, social media site 112 presents a login screen to client device 130 and consumer 132 logs into the social media site 112. If the login is successful, social media site 112 provides the username for the consumer to social savings application 108. In other embodiments, the username is provided to the social savings application 108 through a login screen for logging into social savings application 108. In such embodiments, social savings application 108 maintains login credentials for the user such as a username and password.

At step 302, social savings application 108 requests social media site contacts, also referred to as friends or subscribers, associated with or linked to the consumer from one or more social media sites. For example, social savings application 108 requests social media site contacts 170 from social media site 112. Social media site contacts can include, for example, people listed as “friends” or “followers” of the consumer on the social media site or anyone that the consumer is “following.” In general, any person that receives content concerning consumer 132 through the social media site or any person that consumer 132 receives content about through the social media site may be considered one of consumer 132's contacts (friends) on the social media site. Social media site contacts (friends) associated with consumer 132 may also include site visitors that have been granted access to user content, such as user content 140, associated with consumer 132. Such access is often granted by consumer 132 through a user interface provided by social media site 112. The content provided by the social media site can include text, images, and video, for example.

To request the social media contacts, social savings application 108 first retrieves social media sites associated with consumer 132 from social media list 111 of user data 107. Social media list 111 may include a single social media site or multiple social media sites. Note that in embodiments in which each user is assumed to use the same social media site(s), this step is not needed. Social savings application 108 then retrieves tokens for the login credentials for consumer 132 on each of the social media sites. In accordance with some embodiments, each entry in social media list 111 includes a token that has been previously provided to social savings application 108 when consumer 132 granted rights to social savings application 108 to access their social media site information. The token is passed to the social media site 112 when requesting the consumer's contacts on the social media site so that social media site 112 can ensure that social savings application 108 has been granted permission to access the contacts information for this user. In accordance with embodiments in which the consumer logs into the social media site as part of logging into social savings application 108, a token is returned to social savings application 108 by social media site 112 when the login is successful. After receiving the token(s) for the consumer on the social media site(s), social savings application 108 uses the token(s) to request the list of contacts for the consumer from the social media site(s).

At step 304, social savings application 108 receives the list(s) of social media site contacts associated with consumer 132 from the social media site(s). This list may take the form of usernames on the social media site.

At step 306, social savings application 108 identifies a subset of the social media site contacts returned at step 204 that are registered users of social savings application 108. To identify which of the social media site contacts are registered users of social savings application 108, social savings application 108 searches for the social media site contacts in user database 105. In accordance with embodiments where social media site usernames are stored as part of social media list 111, social savings application 108 searches for each of the social media site contacts in the social media list 111 of each user data record 107. If a social media contact username is found in one of the social medial lists 111, the corresponding username 109 is retrieved from the user data record 107. In accordance with embodiments where the social media site username is the same as the social savings application username, social savings application 108 searches for the social media site contacts in username field 109 of each user data record 107 of social savings application 108. The contacts that are found through this search form a subset of the social media site contacts returned by the social media site(s). This subset of social media contacts can also be referred to as a subset of friends in the list of friends returned by the social media site(s).

At step 308, social savings application 108 retrieves a savings amount for each user in the subset of social media contacts identified in step 306. This savings amount is stored in user data 107 as part of redeemed offers 119 and represents the amount of money the user has saved by redeeming offers at a retail store. The redeemed offers 119 can include both offers redeemed at physical (brick-and-mortar) stores and at online stores. In some embodiments, the savings amount is a total amount saved since the user started using the social savings application. In other embodiments, the savings amount is the amount the user has saved over some period of time such as year-to-date, the past year, and the past month, for example.

At step 310, social savings application 108 generates a savings leaderboard user interface that contains an ordered list of the users identified in step 306, wherein the users are ordered based on the savings amounts retrieved at step 308. The ordered list includes a display name for each user in the list and the savings amount. The ordered list also includes the current user's display name and savings amount. In some embodiments, the current user's display name is highlighted in the ordered list so that it is easier for the current user to locate their display name in the ordered list to determine where they rank. The ordered list can also include a rank number for each user in the list to indicate where each user ranks relative to the other users in the ordered list.

At step 312, social savings application 108 transmits the user interface generated in step 310 to the current user's device, such as client device 130 of FIG. 1. The portion of the user interface containing the ordered list can be transmitted when the user first logs into the social savings application or when the user selects a control on a user interface to request the ordered list.

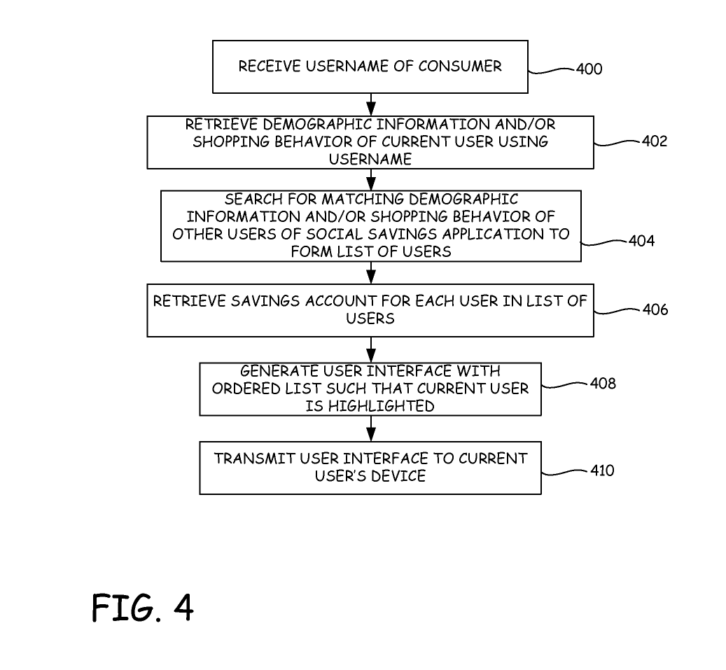

FIG. 4 provides a flow diagram of a method of generating and displaying a savings leaderboard based on a linking criterion of social media contacts. At step 400, a username of a consumer 132 are received by a social savings application 108. These user credentials can be received in response to a login screen sent to client device 130 by social savings application 108, for example.

At step 402, social savings application 108 retrieves demographic information 121 and/or shopping behavior attributes 123 from user data 107 for the current user, consumer 132. Demographic information 121 can include one or more items of demographic information such as the current user's age group, gender, marital status, parenthood status, residence address, home ownership and so forth, for example. Shopping behavior attributes 123 can include one or more shopping behavior attributes such as shopping frequency, average dollar amount spent, categories of items purchased, average number of offers redeemed per shopping trip and so forth, for example.

At step 404, social savings application 108 searches for matching demographic information 121 and/or matching shopping behavior attributes 123 of other users of social savings application 108. This search can be performed against all of the user data records 107 in user database 105 to produce a list of users that share demographic information and/or shopping behavior attributes with the current user.

At step 406, social savings application 108 retrieves a savings amount for each user in the list of users identified in step 404. This savings amount is stored in user data record 107 for each user as part of redeemed offers 119 and represents the amount of money the user has saved by redeeming offers at a retail store. The redeemed offers 119 can include both offers redeemed at physical (brick-and-mortar) stores and at online stores. In some embodiments, the savings amount is a total amount saved since the user started using the social savings application. In other embodiments, the savings amount is the amount the user has saved over some period of time such as year-to-date, the past year, and the past month, for example.

At step 408, social savings application 108 generates a savings leaderboard user interface that contains an ordered list of the users identified in step 404, wherein the users are ordered based on the savings amounts retrieved at step 406. The ordered list includes a display name for each user in the list and the savings amount. In some embodiments, the ordered list can also include an image for each user. In some embodiments, the current user's display name is highlighted in the ordered list so that it is easier for the current user to locate their display name in the ordered list to determine where they rank. The ordered list can also include a rank number for each user in the list to indicate where each user ranks relative to the other users in the ordered list.

At step 410, social savings application 108 transmits the user interface generated in step 408 to the current user's device, such as client device 130 of FIG. 1. The portion of the user interface containing the ordered list can be transmitted when the user first logs into the social savings application or when the user selects a control on a user interface to request the ordered list.

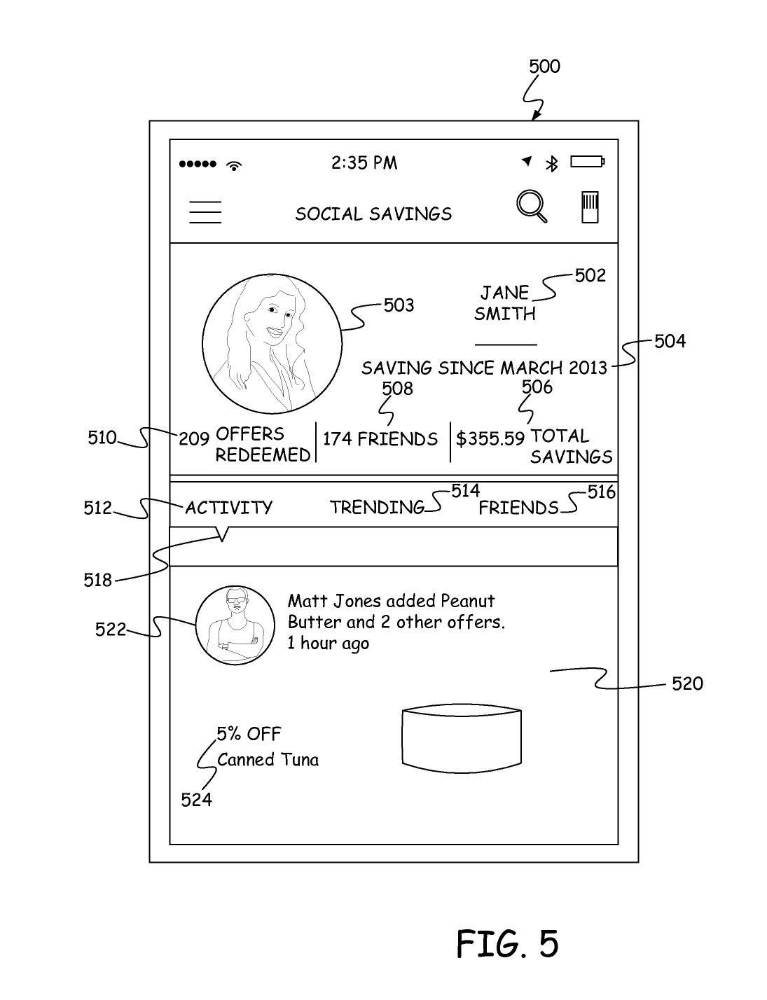

FIG. 5 provides an example of a user interface 500 on client device 130 that includes a savings leaderboard tab 516. User interface 500 identifies a current user by their display name 502 and an image 503. User interface also provides a date 504 when the current user began using the social savings application, the total savings amount 506 for the current user, the number of friends 508 of the current user and the number of offers redeemed 510 for the current user. Total savings amount 506 represents the amount the current user has saved by redeeming offers provided by social savings application 108 at physical stores and/or online stores. The number of friends 508 of the current user can include the number of contacts on social media site 112 that also use social savings application 108.

User interface 500 includes selectable ACTIVITY tab 512, TRENDING tab 514, and FRIENDS tab 516, which acts as the savings leaderboard tab. In FIG. 5, ACTIVITY tab 512 is currently selected causing recent activity information to be displayed in lower portion 520 of user interface 500. In the embodiment shown in FIG. 5, the recent activity includes a posting 522 that a friend has recently selected an offer for peanut butter and a recently added offer 524 for canned tuna. By selecting the TRENDING and FRIENDS labels, the user is able to change the contents of lower portion 520.

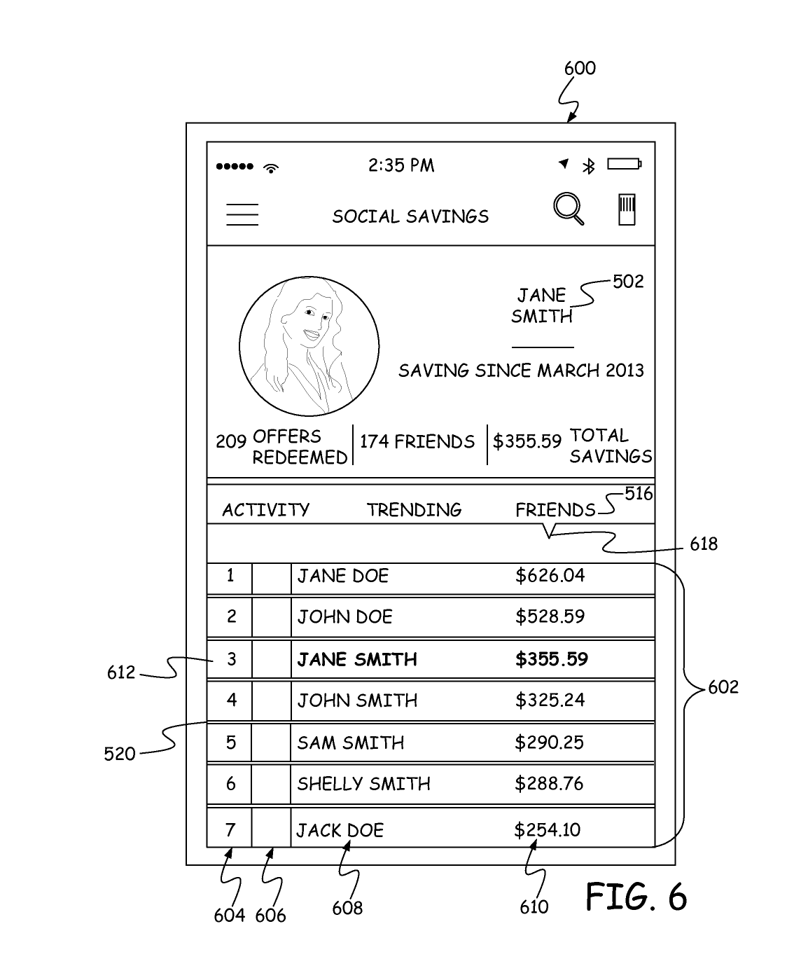

FIG. 6 provides an example of a user interface 600 with FRIENDS tab 516 selected as indicated by graphic 618. When FRIENDS tab 516 is selected, a savings leaderboard 602 is displayed in lower portion 520. Savings leaderboard 602 provides a list of the social media contacts of user 502, as well as user 502, ranked based on the amount each has saved using social savings application 108. Savings leaderboard 602 includes rankings column 604, image column 606, name column 608, and savings column 610 such that each social media contact in savings leaderboard 602 has a rank, image, name, and savings amount. In addition, as shown by entry 612, savings leaderboard 602 highlights the entry for the current user so that the current user can quickly find where they rank in savings leaderboard 602. In the embodiment of FIG. 6, this highlighting takes the form of bolding the name and savings amount for the current user, but in other embodiments, other techniques are used to highlight the current user.

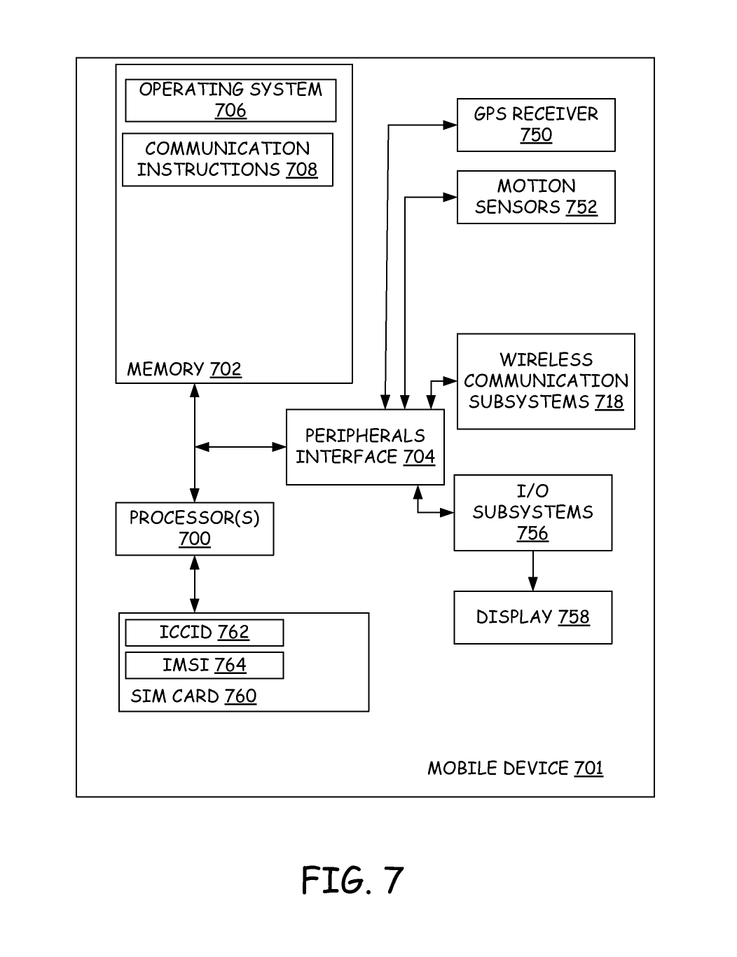

FIG. 7 illustrates a block diagram of mobile device 701. Mobile device 701 includes one or more processors 700, such as a central processing unit or image processors, and a memory 702. Processor(s) 700 and memory 702 are connected by one or more signal lines or buses. Memory 702 can take the form of any processor-readable medium including a disk or solid-state memory, for example. Memory 702 includes an operating system 706 that includes instructions for handling basic system services and performing hardware-dependent tasks. In some implementations, operating system 706 can be a kernel. Memory 702 also includes various instructions representing applications that can be executed by processor(s) 700 including communication instructions 708 that allow processor 700 to communicate through peripherals interface 704 and wireless communication subsystems 718 to a wireless cellular telephony network and/or a wireless packet switched network.

Peripherals interface 704 also provides access between processor(s) 700 and one or more of a GPS receiver 750, motion sensors 752, and input/output subsystems 756. GPS receiver 750 receives signals from Global Positioning Satellites and converts the signals into longitudinal and latitude information describing the location of mobile device 701. The position of mobile device 701 may also be determined using other positioning systems such as Wi-Fi access points, television signals and cellular grids. Motion sensors 752 can take the form of one or more accelerometers, a magnetic compass, a gravity sensor and/or a gyroscope. Motion sensors 752 provide signals indicative of movement or orientation of mobile device 701. I/O subsystems 756 control input and output for mobile device 701. I/O subsystems 756 can include a touchscreen display 758, which can detect contact and movement or break thereof using any of a plurality of touch sensitivity technologies including, but not limited to capacitive, resistive, infrared and surface acoustic wave technologies as well as other proximity sensor arrays or other elements for determining one or more points of contact with display 758. Other inputs can also be provided such as one or more buttons, rocker switches, thumb wheel, infrared port, USB port and/or pointer device such as a stylus.

Mobile device 701 can also include a subscriber identity module, which in many embodiments takes the form of a SIM card 760. SIM card 760 stores an ICCID 762 and an IMSI 764. ICCID 762 is the Integrated Circuit Card Identifier, which uniquely identifies this card on all networks. IMSI 764 is the international mobile subscriber identity, which identifies the SIM card on an individual cellular network. When communicating through wireless communication subsystems 718, processor(s) 700 can use identifiers 762 and/or 764 to uniquely identify mobile device 701 during communications. In accordance with many embodiments, SIM card 760 is removable from mobile device 701 and may be inserted in other devices.

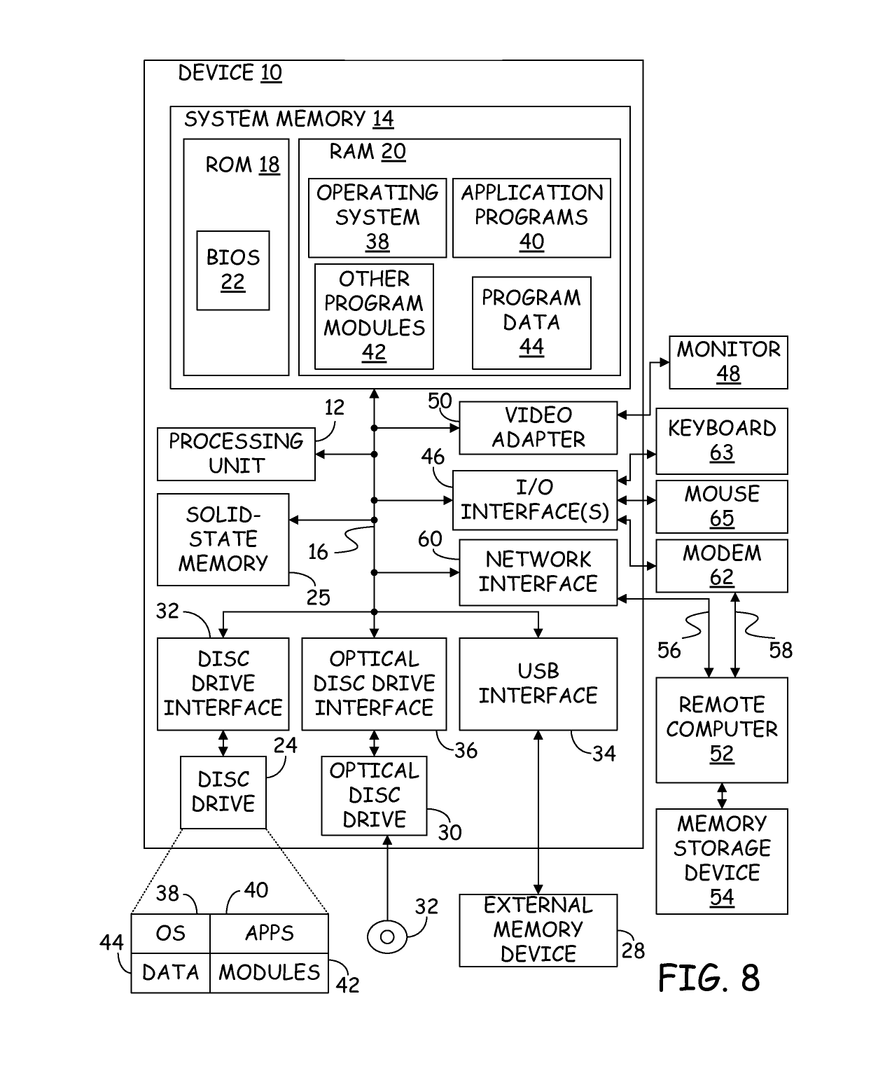

FIG. 8 provides an example of a computing device 10 that can be used as a client device, server device, data processing device or data warehouse device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing social savings server 102, for example. Program data 44 may include data such as user data records 107 and vendor offers 104, for example.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 8. The network connections depicted in FIG. 8 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 8 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
identifying a set of users of a savings application based on a logged-in user of the savings site and a linking criterion;
retrieving a savings amount for each user in the set of users, the savings amount in part based on an amount saved on retail purchases using the savings application; and
generating instructions representing a user interface that displays the set of users and the savings amount for each user as an ordered list based on savings amounts.

2. The computer-implemented method of claim 1 wherein the linking criterion comprises users of the savings application that are associated with the logged-in user on a social media site.

3. The computer-implemented method of claim 2 wherein for each user, the amount saved on retail purchases using the savings application comprises a total dollar amount of offers redeemed by the user.

4. The computer-implemented method of claim 3 wherein at least one of the offers was redeemed by the user at a physical store.

5. The computer-implemented method of claim 4 wherein at least one of the offers was redeemed by the user at an online store.

6. The computer-implemented method of claim 1 wherein generating a user interface that displays the list of users comprises highlighting the logged-in user in the list of users.

7. The computer-implemented method of claim 1 wherein the linking criterion comprise users of the savings application with similar demographic information to the logged-in user.

8. The computer-implemented method of claim 1 wherein the linking criterion comprise users of the savings application with similar shopping behavior to the logged-in user.

9. A hardware computer-readable medium having computer-executable instructions stored thereon that cause a processor to perform steps comprising:
providing a user interface showing a set of users ordered by the amount of money each user saved by redeeming retail offers.

10. The hardware computer-readable medium of claim 9 wherein the set of users comprises users who are associated with a current user on a social media site.

11. The hardware computer-readable medium of claim 9 wherein the set of users comprises users who share at least one demographic attribute with a current user.

12. The hardware computer-readable medium of claim 9 wherein the set of users comprises users who share at least one shopping behavior with a current user.

13. The hardware computer-readable medium of claim 9 wherein the user interface highlights an identifier for a current user in the set of users.

14. The hardware computer-readable medium of claim 9 wherein the amount of money saved by each user comprises an amount of money saved by redeeming offers at a bricks-and-mortar store.

15. A computer-implemented method comprising:
identifying a set of users associated with a current user, the current user and each user in the set of users having a respective username;
for each user in the set of users and the current user, retrieving an amount the user saved by redeeming offers; and
transmitting, by a server, a list containing the username of the current user and usernames of each user in the set of users ordered based on the amounts saved by redeeming offers.

16. The computer-implemented method of claim 15 wherein identifying a set of users comprises retrieving a set of usernames of users associated with the current user on a social media site.

17. The computer-implemented method of claim 15 wherein identifying a set of users comprises retrieving a set of usernames of users that share a demographic parameter with the current user.

18. The computer-implemented method of claim 15 wherein identifying a set of users comprises retrieving a list of usernames of users that have similar shopping behavior to the current user.

19. The computer-implemented method of claim 15 wherein transmitting the list of usernames comprises transmitting the username of the current user such that the username of current user is highlighted.

20. The computer-implemented method of claim 15 wherein the amount the user saved by redeeming offers comprises an amount the user saved by redeeming offers at physical stores.
